(19) United States
(12) Patent Application Publication
(10) Pub. No.: US 2008/0268984 A1
(43) Pub. Date: Oct. 30, 2008

(54) Process and System for Producing or Generating a Map

(76) Inventors: Stephen Mair, Surrey (GB); Simon Roper, Berkshire (GB)

Correspondence Address: MICHELLE L. EVANS, GUNN & LEE, P.C., 700 NORTH ST. MARY'S, SUITE 1500, SAN ANTONIO, TX, 78205, US

(21) Appl. No.: 10/594,729

(22) PCT Filed: Mar. 29, 2005
(86) PCT No.: PCT/GB2005/001212

§ 371 Date: Nov. 28, 2006

(30) Foreign Application Priority Data
Mar. 29, 2004 (GB) 0407060.3

(51) Int. Cl. A63B 69/36; G01C 21/00

(52) U.S. Cl. 473/407; 701/213

(57) ABSTRACT

The present invention relates to a process for generating a map of a hole of a golf course, the map including at least one graduation showing the distance between a pin and a fixed point on the hole, the process including the steps of taking a GPS reading of the location of the pin; and generating the map based on the reading. There is also provided a system to carry out the process of the invention, together with a map generated by the process of the present invention.

The present invention relates to a process and system for producing or generating a map. In particular, the present invention relates to a process and system for producing or generating a map of a golf course. More particularly, the present invention relates to a process and system for producing or generating a golf course guide, which is graduated to show the distance from at least one fixed point on a hole of the golf course to the pin or pin position of that hole.

Generally, golf course guides include a map of each hole of the course, which are usually graduated illustrating the distance from the tee to the front or centre of the green or vice versa, and to hazards such as bunkers and water.

The main advantage of a golf course guide is that they can assist golfers of all abilities to select the most appropriate club, that is, in the light of their position on the hole. As will be appreciated this can speed up play.

One of the major disadvantages of current golf course guides is that they do not actually show or represent the distance to the actual pin and, as such, are not that accurate. This is primarily occasioned by the fact that it is common practice to regularly relocate, sometimes daily, the pin on the green. As will be appreciated, such relocation can result in the pin moving tip to 30 or 40 metres from its previous location.

There are several patents granted regarding GPS and golf courses. They all use GPS on either golf buggies or PDA handheld. As will be appreciated, GPS on buggies or on handhelds are bulky, expensive and create a security issue to the golf course with potential lost units. The purpose of this system is to create a highly portable solution, a card, that is inexpensive, and is available for all golf courses and golfers, and not restricted to top end resort courses.

The Global Positioning System (GPS) was introduced by the U.S. Department of Defence with a view to providing a precise form of world wide positioning.

The GPS is a worldwide radio-navigation system formed from a constellation of 24 satellites and their ground stations. GPS uses these “man-made stars” as reference points to calculate positions on the earth, which are accurate to a matter of metres. In fact, with advanced forms of GPS, measurements can be taken, which are accurate to less than a centimetre.

To Increase the level of accuracy of GPS over Europe, the European Space Agency, the European Commission and Eurocontrol, have launched a project called EGNOS (European Geostationary Navigation Overlay Service).

EGNOS consists of three geostationary satellites and a network of ground stations that transmit signals containing information on the reliability and accuracy of the positioning signals sent out by GPS.

By early 2004, the full network needed for this augmentation system will have been deployed all around Europe and beyond. It will comprise monitoring stations, called RIMSs (Ranging and Integrity Monitoring Stations), and several Master Control Centres, the first of which is already installed in Langen, Germany. Altogether, nearly 40 stations will be deployed.

An object of the present invention is to provide a golf course guide which overcomes or at least addresses the disadvantages outlined above. In particular, an object of the present invention is to provide a system and process, which utilise GPS to provide a more accurate and up-to-date golf course guide, which is readily producible, can even be produced on demand or even daily, and moreover, is graduated showing the current, real distance between at least one fixed point on a hole and the pin.

According to a first aspect of the present invention, there is provided a process for generating a map of a hole of a golf course, the map including at least one graduation showing the distance between a pin and a fixed point on the hole, the process including the steps of:

taking a GPS reading of the location of the pin; and
generating the map based on the reading.

As will be appreciated, the process of the present invention enables an up-to-date, accurate map of a hole, which shows the distance between at least one fixed point on the hole to the pin, to be readily generated as soon as the pin is relocated. The process of the present Invention will allow accuracy of 2 metres, 1 metres, ½ metre, ¼ metre right down to 5 cm accuracy. This is done through the set up and type of equipment used to carry out the process of the present invention.

Preferably, the GPS reading is taken by placing a hand held GPS receiver over the pin, for example, a GEO EXPLORER XT supplied by Trimble Navigation Ltd, Sunnyvale, Calif., USA or a RECON supplied by 20 Tripod Datasystems (TDS) Oregon, USA.

Further preferably, the GPS reading is taken by locating a pole mounted receiver in the pin, for example, TRIMBLE.

Advantageously, the map is generated by printing graduations on a card which already includes a graphic representation of the hole,

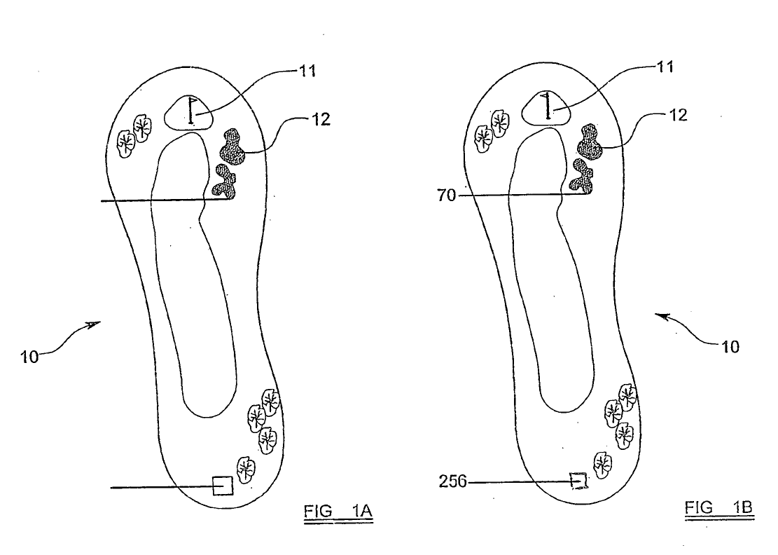

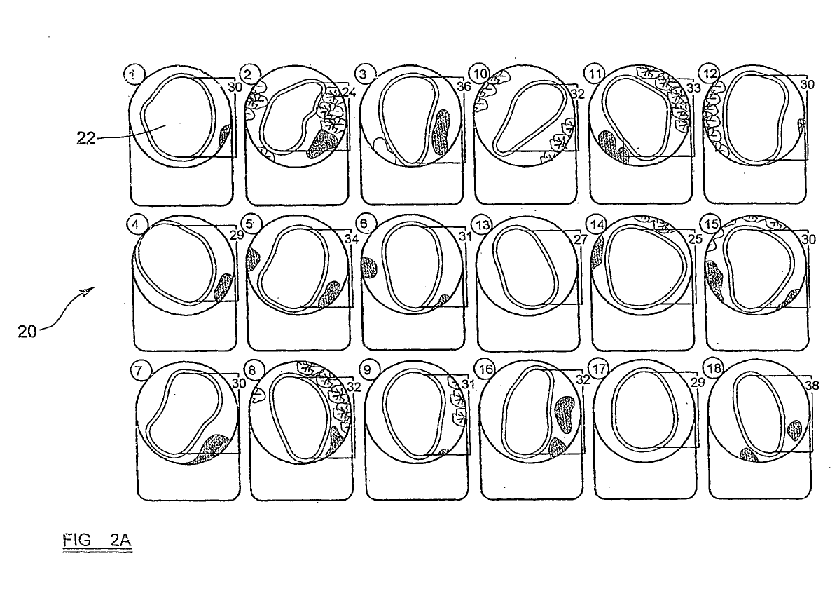

Two non-limiting embodiments of the process of the present invention will now be described below with reference to FIGS. 1A and B, 2A and 2B, which Illustrates a map generated in accordance with the process of the present invention.

Firstly, and as will be appreciated, before a golf course guide can be generated, it will be necessary to actually map the golf course.

Although the present invention is not primarily concerned with the Initial mapping procedure per se, it will nevertheless be described below for the sake of completeness. The mapping process used creates a map that is accurate to 3 cm. Many GPS mapping processes used can create the same result, a map, but the accuracy can be in excess of 1 or 2 metres.

One way of initially mapping a golf course-involves taking aerial photographs of the course from a height of at least 2000 feet using, for example, Ordinance Survey equipment. Once taken, a graphic of each hole on the course can be produced utilising a GPS mapping device. That is, GPS reference points can be taken from various fixed points from the aerial photograph and a graphic of each hole of the course can be produced via the process of aerial triangulation. Such graphic can then be incorporated into a golf course guide, which may be in the form of a booklet or even a card.

A second way of Initially mapping a golf course, which does not require the use of aerial photography, involves mapping the course on foot. This involves the use of a GPS mapping device and entails walking the course and taking a number of GPS reference points on the course. Once the entire course GPS referenced, a graphic of each hole of the course can be generated. Once again, such graphic can be incorporated into a golf course guide in the form of a booklet or even a card.

As touched upon above, the present invention is not primarily concerned with the initial mapping procedure, but rather, is concerned with updating a highly accurate template of the graphic such that an up-to-date graduated graphic, which takes into account any changes in the course, for example, the relocation of the pin, can be readily generated and Incorporated into a golf course guide.

In accordance with the present invention, in the event that the pin is moved, which they regularly are, a greenkeeper or other person associated with the course, will proceed to the new location of the pin with a GPS receiver, that is, in order to take a new GPS reference point. Such a receiver, can either be a hand held GPS receiver, for example, a GEO EXPLORER XT supplied by Trimble Navigation Ltd, Sunnyvale, Calif., USA or a RECON supplied by Tripod Datasystems (TDS), Oregon, USA. In use, the receiver would be positioned over the new hole and a new reading would be taken. Alternatively, and for more accuracy, the aforementioned receiver could be used in combination with what is known in the art as a “beacon on the belt”, namely, a pole mounted aerial. In use, the pole, upon which the beacon is mounted, would be located in the hole such that a GPS reading could be taken. In addition, a further reading would be taken with the hand held receiver as described above. In a further embodiment, any one of the aforementioned receivers could be mounted on a tripod, which, in use, would be located over the hole such that the appropriate readings could be taken.

Once the new GPS reference point has been recorded, it is then relayed back to a database or host system, which includes or holds the original graphic of the hole and/or its associated graduations i.e. the original template of the map. The template is then automatically updated to incorporate the current location of the pin and a new graphic of the hole showing the new graduated location of the pin can be automatically generated. Such graphic can then be printed out to be incorporated into a course guide either in the form of a booklet or a card. It is to be understood that the resultant graphic can be in colour or in black and white. In addition, it is also to be understood that the template, which is to be updated, may consist solely of the graduations and it is the graduations themselves which are printed onto a pre-existing map or graphic representation of the hole. For example, and with reference to FIGS. 1A and B, a card is provided which includes a graphic representation of a hole 10 on a golf course. As can be seen such graphic illustrates the location of the pin 11 and some bunkers 12.

In the event that the card is to be graduated, that is, once the appropriate readings have been taken, the card is placed in a receiving tray of a printer and the graduations or measurements illustrating the distance from two fixed points to the pin can be printed as an overlay onto the card. This is illustrated by FIG. 1B.

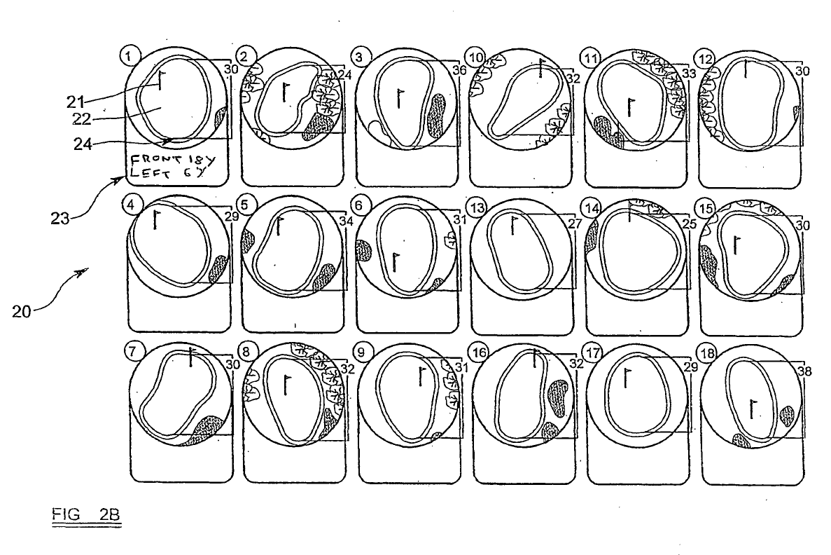

As illustrated in FIG. 2A, the template 20 to be updated includes a graphic of each green of the golf course. Once the location of the pin is determined in accordance with the present invention, then, and as illustrated in FIG. 2B, the template is updated to show the location of the pin 21 on the green 22 and moreover, the template is graduated 23 to show the distance from the front point of the green 24 (“a fixed point”) to the pin 21. For example, and with further reference to FIG. 2B, the template of the green of the first “tee” (marked with the numeral “1” within a circle) is graduated at 23 to show that the pin is located eighteen yards from the front of the green and six yards left from the front of the green i.e. the map is graduated so that the distance from a fixed point, in this case the front of the green, to the pin is shown. Although not illustrated, the remaining templates for the holes “2” through to the “18^{th}” can also be graduated.

As above, once updated, a card or booklet can be generated which includes a graduated graphic of a map of the hole, in this case the green. In addition, and as above, in the event that the card is to be graduated, that is, once the appropriate readings have been taken, the card is placed in a receiving tray of a printer and the graduations or measurements Illustrating the distance from the fixed point, namely, the front of the green, to the pin can be printed as an overlay onto the card.

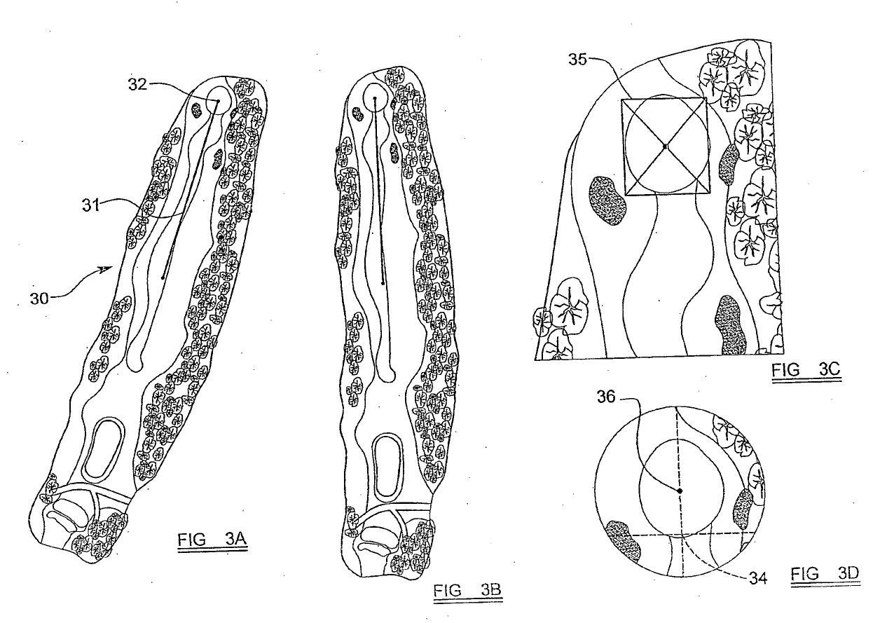

The manner in which the front point 34 of a green 32 can be determined is illustrated with reference to FIGS. 3A-D. As illustrated in FIG. 3A, a line 31 is made on a template 30 of a graphic/aerial photograph of a hole between the centre of the green and the point on the fairway where an approach shot to the green is likely to be made from. As illustrated in FIG. 3B, the image is rotated until such time as the line 31 is vertically straight. A box 35 is then drawn around the green 32 from the outermost edges (see FIG. 3C). To finish, the front 34 and back 35 points of the green are marked using the line 31 going through the centre of the green point 36.

Although the present invention has been described by way of reference to updating the graduations pertaining to the location of the pin, it is to be understood that any location on a hole can be updated.

In a further aspect of the present invention there is provided a system for generating a map of a hole of a golf course, the map including at least one graduation showing the distance between a pin and a fixed point on the hole,

the system including:
means for taking a GPS reading of the location of the pin; and
means for generating the map based on the reading.

Preferably, the means for taking a GPS reading includes a handheld GPS receiver, for example, a GEO EXPLORER XT supplied by Trimble Navigation Ltd, Sunnyvale, Calif., USA or a RECON supplied by Tripod Datasystems (TDS) Oregon, USA.

Further preferably, the means for taking a GPS reading include a pole mounted GPS receiver, for example, a TRIMBLE.

Advantageously, the means for generating the map include a printer, preferably a colour printer, laser or otherwise.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A process for generating a map of a hole of a golf course, the map including at least one graduation showing the distance between a pin and a fixed point on the hole, the process including the steps of:
taking a GPS reading of the location of the pin; and
generating the map based on the reading.

2. The process of claim 1, wherein the GPS reading is taken by placing a hand held GPS receiver over the pin.

3. The process of claim 1 or 2, wherein the GPS reading is taken by locating a pole mounted receiver in the pin.

4. The process of any one of claims 1 to 3, wherein the map is generated by printing graduations on a card which includes a graphic representation of the hole.

5. A system for generating a map of a hole of a golf course, the map including at least one graduation showing the distance between a pin and a fixed point on the hole, the system including;
means for taking a GPS reading of the location of the pin; and
means for generating the map based on the reading.

6. The system of claim 5, wherein the means for taking a GPS reading includes a handheld GPS receiver.

7. The system of claim 5 or 6, wherein the means for taking GPS reading include a pole mounted GPS receiver.

8. The system of any one of claims 5 to 7, wherein the means for generating a map include a printer.

9. A process for generating a map of a hole of a golf course, the map including at least one graduation showing the distance between a pin and a fixed point on the hole substantially as hereinbefore described and exemplified.

10. A system for generating a map of a hole of a golf course, the map including at least one graduation showing the distance between a pin and a fixed point on the hole substantially as herein before described.

11. A map produced by the process of any one of claims 1 to 4.
